(19) United States
(12) Patent Application Publication
(10) Pub. No.: US 2015/0013554 A1
(43) Pub. Date: Jan. 15, 2015

(54) STORING AND DISPENSING DEVICES AND METHODS

(71) Applicant: Chef'n Corporation, Seattle, WA (US)

(72) Inventors: David A. Holcomb, Seattle, WA (US); Matthew Krus, Seattle, WA (US)

(21) Appl. No.: 14/323,400

(22) Filed: Jul. 3, 2014

Related U.S. Application Data
(60) Provisional application No. 61/844,603, filed on Jul. 10, 2013.

(51) Int. Cl. B30B 1/20; A47J 19/00

(52) U.S. Cl. CPC B30B 1/20; A47J 19/00
USPC 100/35; 100/289

(57) ABSTRACT

Devices and methods for storing and dispensing herbs can incorporate a container, a cap and an insert. The container has an opening extending from a proximal to an opposing distal end. An interior wall of the container is threaded at least a portion of its longitudinal length. The cap is releasably coupleable with the distal end. The insert, which is engaged with the proximal end, has a handle at one end and a head at an opposing end. The head of the insert is threadedly coupled to the interior wall of the container such that rotation of the handle results in movement longitudinally along the container. As a result, rotation of the handle when the head and the cap are coupled to the container results in compression of herbs or the like; and further rotation of the handle when the cap is removed results in the herb being forced out of the container.

### BACKGROUND OF THE INVENTION

1. Field of the Invention

The present disclosure generally is related to kitchen tools, and more particularly, to tools for storing and dispensing herbs and the like.

2. Description of the Related Art

Herbs and other cooking ingredients often are purchased fresh or dried, and can be used to flavor food when cooking. Fresh herbs can be cut into small pieces and sprinkled onto or into food when cooking or before being eaten. Similarly, dried herbs can be shaken from a container.

Fresh herbs often are preferred over dried herbs due to their flavor and/or texture. Fresh herbs, however, are perishable and can be more difficult or expensive to obtain in certain geographic areas or at certain times of year. Having fresh ingredients available more often is something many people would enjoy.

### BRIEF SUMMARY OF THE INVENTION

The present disclosure is directed toward devices and methods for storing and dispensing herbs and the like. Certain embodiments incorporate a container, a cap and an insert. The container has an opening extending from a proximal end thereof to an opposing distal end. An interior wall of the container is threaded at least a portion of its longitudinal distance between the proximal and distal ends. The cap is releasably coupleable with the distal end of the container. The insert, which is engaged with the proximal end of the container, has a handle at one end and a head at an opposing end. The head of the insert is threadedly coupled to the interior wall of the container such that rotation of the handle of the insert relative to the container results in movement of the head longitudinally along the container. As a result, rotation of the handle of the insert when the head is coupled to the container and the cap is coupled to the container results in compression of herbs or the like between the head and the cap; and further rotation of the handle when the cap is removed from the container results in the herb being forced out of the distal end of the container.

### BRIEF DESCRIPTION OF THE SEVERAL VIEWS OF THE DRAWING(S)

FIG. 1 is a perspective view of an herb container and dispenser, according to an embodiment of the present invention.

FIG. 2 is a top pan view of the herb container and dispenser of FIG. 1.

FIG. 3 is a bottom pan view of the herb container and dispenser of FIG. 1.

FIG. 4 is a cross-sectional view of the herb container and dispenser of FIG. 1, viewed along Section 4-4 of FIG. 2.

FIG. 5 is a cross-sectional view of a container portion of the herb container and dispenser of FIG. 1, viewed along Section 5-5 of FIG. 2.

FIG. 6 is a cross-sectional view of the herb container and dispenser of FIG. 1, shown in a compressing configuration, viewed along Section 6-6 of FIG. 2.

FIG. 7 is a cross-sectional view of the herb container and dispenser of FIG. 1, shown in a dispensing configuration, viewed along Section 7-7 of FIG. 2.

FIG. 8 is a cross-sectional view of the herb container and dispenser of FIG. 1, shown in another dispensing configuration, viewed along Section 8-8 of FIG. 2.

### DETAILED DESCRIPTION

The present disclosure is directed toward devices and methods for storing and dispensing herbs. Details about selected embodiments of the invention are described below and shown in the corresponding drawings. An individual of ordinary skill in the art, having reviewed this entire disclosure, will immediately appreciate that certain details can be eliminated or changed, and that other details can be added to the illustrated embodiments, all without deviating from the spirit of the invention. The inventors consider all such embodiments and details to be within the scope of this disclosure. Accordingly, the invention should be limited only by the claims below, as amended from time to time.

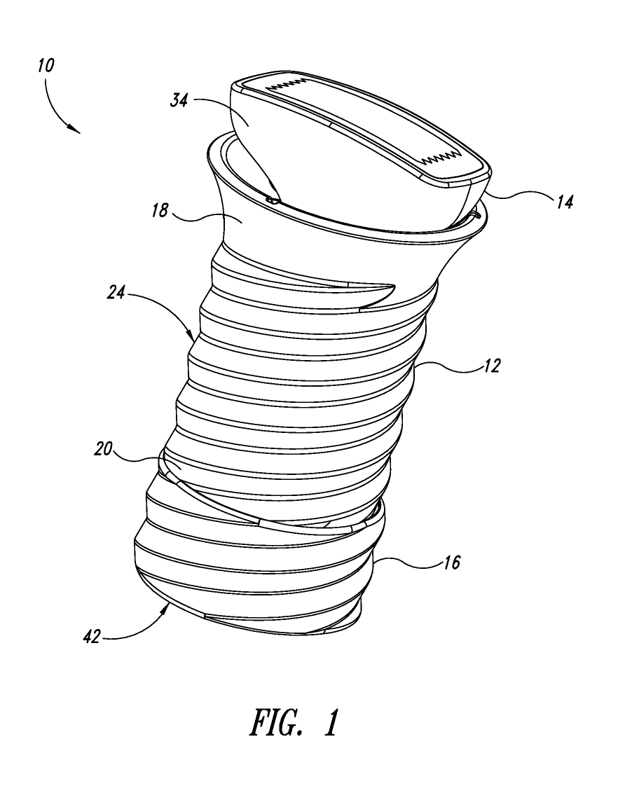

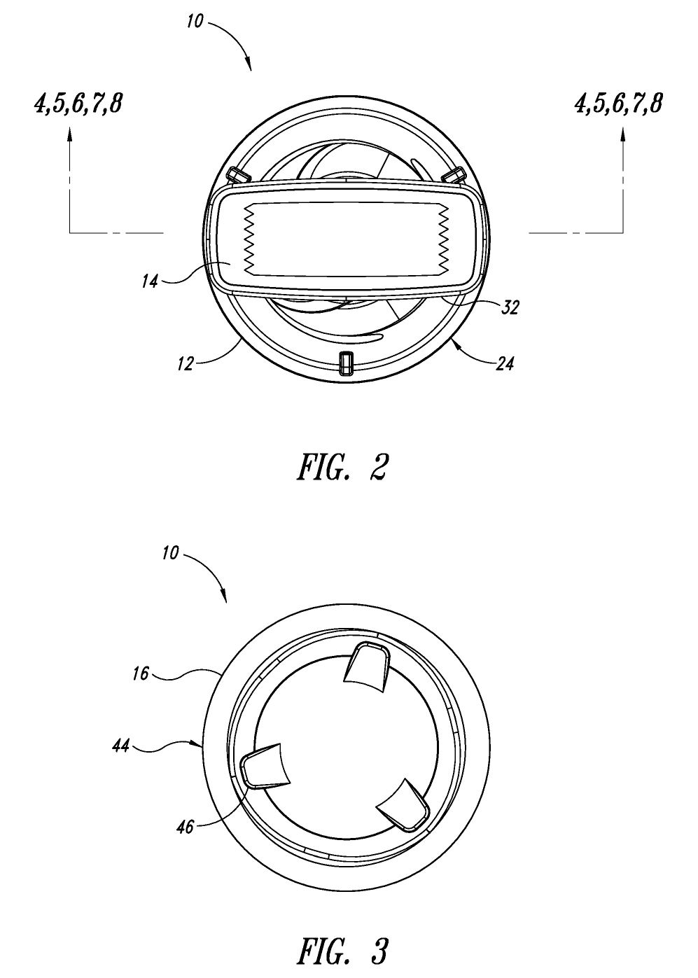

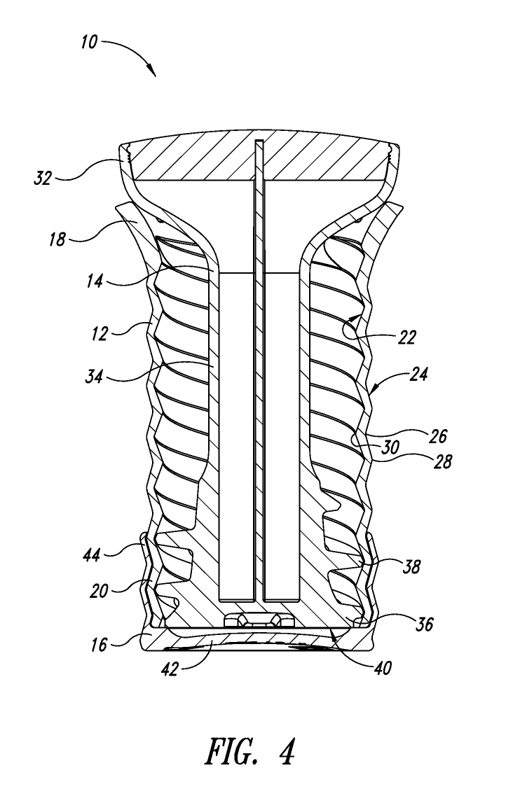

FIGS. 1-4 generally depict one particular embodiment of a device 10 for storing and dispensing herbs or the like. The illustrated device 10 is assembled from a container 12, an insert 14, and a cap 16. The insert 14 enters a proximal end 18 of the container, and the cap 16 encloses the distal end 20 of the container. The device 10 can be sized to fit comfortably with the container in one hand and the insert in the other hand, allowing for easy manipulation of the device. Details regarding the illustrated embodiment are provided in the following paragraphs.

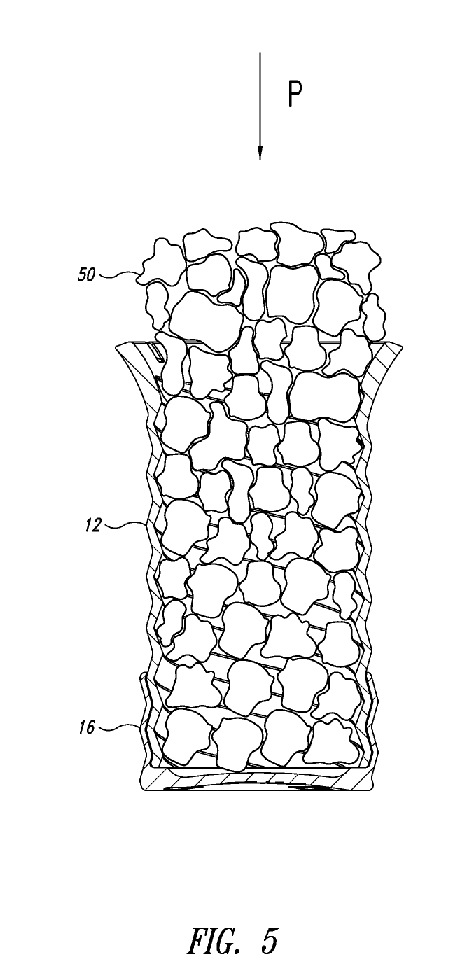

The container 12 is generally cylindrical in shape and has openings at both the proximal end 18 and the distal end 20. The container 12 is threaded along at least a portion of its interior surface 22 for engagement with the insert 14, and along at least a portion of its exterior surface 24 for engagement with the cap 16. In a thin-walled container, such as that shown in FIG. 4, a valley 26 between two teeth 28 on the exterior surface 24 can correspond with a tooth 30 on the interior surface 22, and vice versa, although such a configuration is not necessary. As such, a single thread can helically extend the length of the container 12, both inside and out.

The insert 14 has a handle 32 at one end of a shaft 34 and a head 36 at an opposing end of the shaft. The handle 32 is sized and shaped and, if desired, coated or otherwise treated, to fit comfortably and securely in the user's hand and to be turned by the user during use. The stem 34 is fixed with respect to the handle 32 and the head 36 to rotate as a unit therewith to translate rotational movement of the handle to the head during use. The stem 34 is narrower than the opening at the proximal end 18 of the container 12 to follow the head into the container. The handle 32 need not be smaller than the container 12.

The head 36 is oriented at least substantially perpendicular to the stem 34 of the insert 14 and has a thread 38 extending helically about its perimeter. The thread 38 is sized and shaped to complement the teeth 30 on the interior surface 22 of the container 12. As a result, when the head 36 of the insert 14 is urged against the proximal end 18 of the container 12, with the stem 34 aligned coaxially with the container, and the handle 32 is turned, the thread 38 engages the teeth 30 on the interior surface 22 of the container 12, and the insert moves along the length of the container. Rotation of the handle 32 in one direction results in movement of the insert 14 along the container 12 in a first direction, and rotation of the handle in an opposition direction results in movement of the insert along the container in an opposing direction. Thus, by selectively rotating the handle 32, the user can position the head 36 at any desired position along the length of the container 12.

The terminal end of the head 36 opposite the handle 32 ends in a face 40 sized and shaped to closely complement the shape of the interior surface 22 of the container 12. The face 40 can be flat and perpendicular to the length of the stem 34, or can be contoured and/or treated as suitable for the intended purpose of the device 10. When the insert 14 is fully inserted into the container 12, the face 40 can align with the distal end 20 of the container.

The cap 16 is threaded over the distal end 20 of the container 12, although it could be a plug inserted into the container or a lid hinged to the container, or other configurations, as suitable and/or desired. An end 42 of the cap 16 covers and seals the distal end 20 of the container 12, and a threaded wall 44 of the cap securely couples the cap to the container. The cap 16 can be adapted to remain against the container 12 even when the insert 14 compresses the contents of the container against the cap. The end 42 of the cap 16 can have feet 46 or other features to facilitate standing the device 10 on a countertop or other surface between uses.

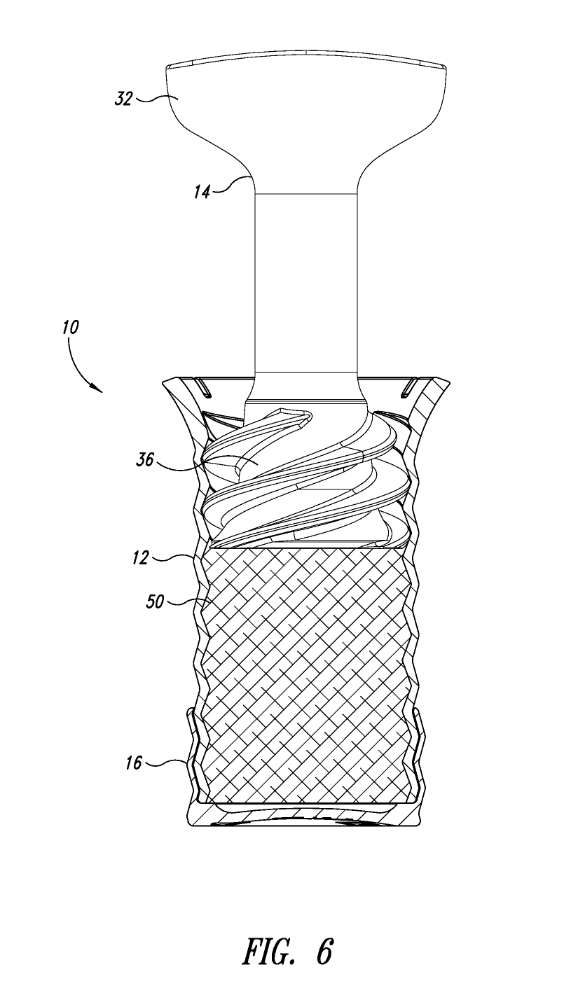

FIGS. 5-8 illustrate the above described embodiment of the device 10 being used to contain and dispense one particular type of an herb 50. As shown in FIG. 5, the cap 16 is secured to the container 12, the insert 14 is removed from the container, and the herb 50 is placed in the container until the container is full or overfull. The user can press the herb 50 into the container 12 using a thumb or other finger or object, in the direction P. By doing so, the user can fill the container 12 with as much compressed herb 50 as desired.

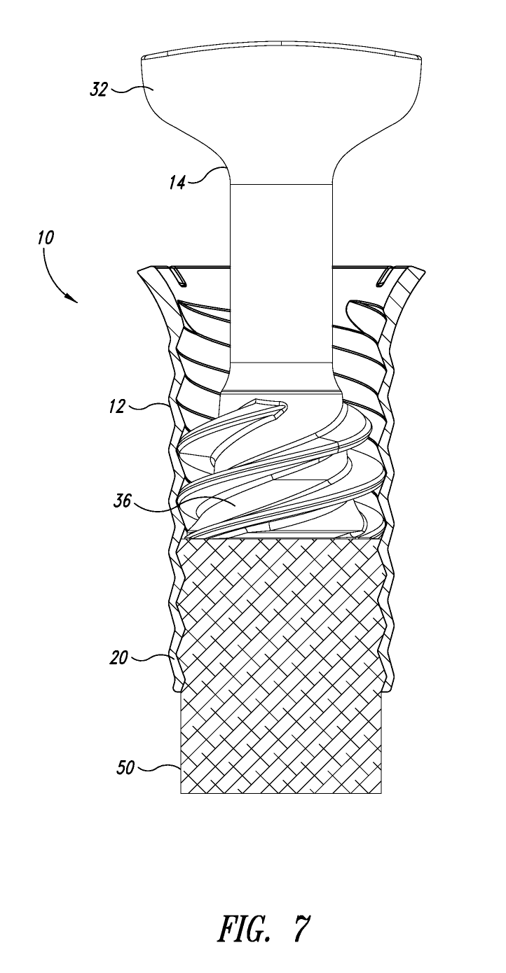

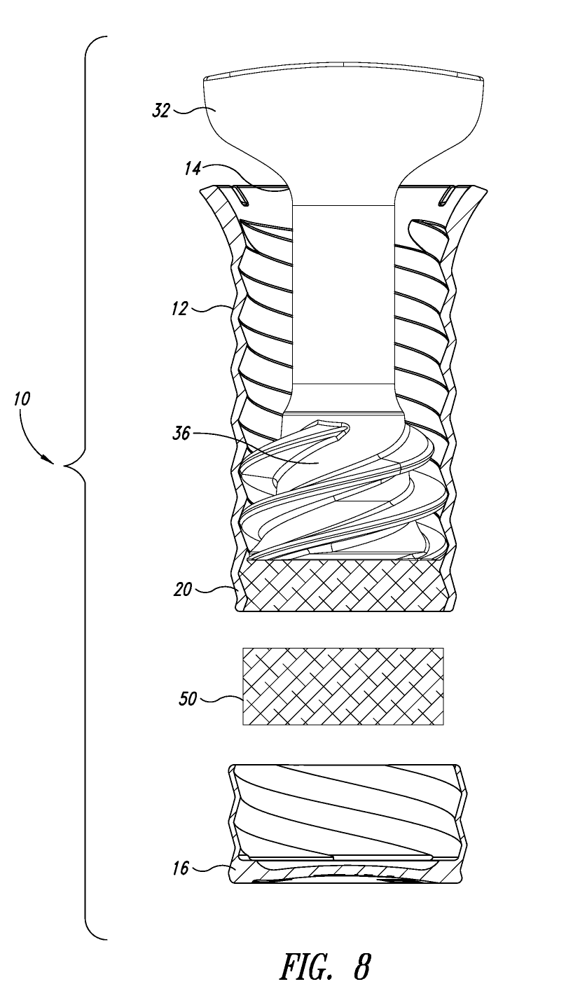

As illustrated in FIG. 6, after the user has filled the container 12 with a desired amount of partially compressed herb 50, the user can engage the insert 14 with the container and begin twisting the handle 32 of the insert to drive the head 36 of the insert into the container. As the head 36 moves into the container 12, the herb 50 continues to be compressed against the cap 16. The user can continue to twist the handle 32 until the herb 50 is fully compressed. At any point, if the container 12 is sufficiently full, the user can stop twisting the handle 32 and the device 10 is ready to be stored or to dispense the compressed herb 50. If the container 12 is not sufficiently full, the user can twist the handle 32 in the opposite direction to remove the insert 14 from the container, add more herbs 50 to the container, and compress more of the herb. Ultimately, when the container 12 has been filled to a desired amount, the user can dispense the compressed herb 50 or put the entire device 10 into a freezer or other location for storage.

When the user is ready to dispense the herb 50, the user can remove the cap 16 from the container 12 and twist the handle 32 of the insert 14 to force the herb 50 out of the distal end 20 of the container, as illustrated in FIG. 7. As the handle 32 is turned, the head 36 moves toward the distal end 20 of the container 12, and the compressed herb 50 is forced out of the container. In the illustrated embodiment, a substantially cylindrical plug of the herb 50 is forced out of the container. The user can turn the handle 32 until a desired amount of the herb 50 has been forced out of the end of the container 12, at which point the user can remove the herb from the plug by cutting it off with a knife or other blade, by grating the end of the plug, or by other suitable means. Removal of the end of the plug of herb 50 can be facilitated by freezing the herb.

After the desired amount of the herb 50 has been removed, the cap 16 can be placed back onto the container 12 and the container with the remaining herb can be re-stored and saved for use at a later time.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device for use in storing and dispensing herbs and the like, the device comprising:
a container having an opening extending from a proximal end thereof to an opposing distal end, an interior wall of the container being threaded at least a portion of a longitudinal distance between the proximal and distal ends;
a cap releasably coupleable with the distal end of the container;
an insert engaged with the proximal end of the container, the insert having a handle at one end thereof and a head at an opposing end, the head being threadedly coupled to the interior wall of the container such that rotation of the handle of the insert results in movement longitudinally along the container; whereby
rotation of the handle of the insert when the head is coupled to the container and the cap is coupled to the container results in compression of herbs or the like between the head and the cap, and further rotation of the handle when the cap is removed from the container results in the herb being forced out of the distal end of the container.

2. The device of claim 1 wherein the container is at least substantially cylindrical.

3. The device of claim 1 wherein an interior surface of the container is at least substantially cylindrical.

4. The device of claim 1 wherein the interior wall of the container is threaded the entire longitudinal distance between the proximal and distal ends.

5. The device of claim 1 wherein the cap is threadedly coupled to the container.

6. The device of claim 1 wherein the head of the insert is at least substantially cylindrical.

7. A method for storing and dispensing herbs and the like, the method comprising:
placing the herbs into a proximal end of a container having an opening extending from the proximal end thereof to an opposing distal end, an interior wall of the container being threaded at least a portion of a longitudinal distance between the proximal and distal ends;
manually placing the herbs into the container against a cap that has been releasably coupled to the distal end of the container;
threading an insert into the container, the insert having a handle at one end thereof and a head at an opposing end, the head being threadedly coupled to the interior wall of the container such that rotation of the handle results in longitudinal movement of the insert along the container; and
rotating the handle while the cap is coupled to the container to compress the herbs between the head and the cap, storing the compressed herbs, then rotating the handle further after the cap has been removed from the container to force the herb out of the distal end of the container.
